(19) United States
(12) Patent Application Publication
(10) Pub. No.: US 2018/0070178 A1
(43) Pub. Date: Mar. 8, 2018

(54) LOUDSPEAKER ARRANGEMENT FOR A MOTOR VEHICLE AND MOTOR VEHICLE

(71) Applicant: GM GLOBAL TECHNOLOGY OPERATIONS LLC, Detroit, MI (US)

(72) Inventors: Christian TABBERT, Ruesselsheim (DE); Markus FROMMANN, Ruesselsheim (DE)

(73) Assignee: GM GLOBAL TECHNOLOGY OPERATIONS LLC, Detroit, MI (US)

(21) Appl. No.: 15/678,776

(22) Filed: Aug. 16, 2017

(30) Foreign Application Priority Data
Aug. 16, 2016 (DE) 102016009945.3

(51) Int. Cl. H04R 5/02; H04R 1/02

(52) U.S. Cl. CPC H04R 5/02; B60R 2011/0003; H04R 2499/13; H04R 1/025

(57) ABSTRACT

A loudspeaker arrangement for a motor vehicle includes a sound generator arranged on a housing, and a mounting arrangement for fixing the loudspeaker arrangement in the motor vehicle. The mounting arrangement is configured to be fixed on an IsoFix mounting of the motor vehicle. The present disclosure furthermore pertains to a corresponding motor vehicle.

### CROSS-REFERENCE TO RELATED APPLICATION

This application claims priority to German Patent Application No. 102016009945.3 filed Aug. 16, 2016, which is incorporated herein by reference in its entirety.

### TECHNICAL FIELD

A loudspeaker arrangement for a motor vehicle and a corresponding motor vehicle are described below.

### BACKGROUND

Most motor vehicles are equipped with loudspeaker arrangements. Motor vehicles present multiple challenges with respect to the design and configuration of loudspeaker systems. On the one hand, the occupants in the passenger compartment are seated in considerably differing extreme positions. This makes it difficult to provide music in equally high quality and stereo resolution for all passengers.

On the other hand, passenger compartments are acoustically complex and the available volume is small. This is particularly problematic for woofers or subwoofers because they require resonance chambers in order to function properly.

The human auditory system is unable to fix the position of frequencies below a limiting frequency such that low-range loudspeakers can be positioned in a motor vehicle in a relatively unrestricted fashion. Consequently, they are frequently arranged in the rear region of the motor vehicle, for example behind the rear seats or in the trunk. However, an arrangement in the trunk reduces the available storage volume.

U.S. Pat. No. 5,591,946 discloses a collapsible loudspeaker with a housing that is horizontally elongated and can be pivoted between an upright position and a horizontally aligned stowage position. In this way, the loudspeaker can be stowed underneath a folding seat.

This technology requires a fold-up seat, which can be expensive because the seat requires a complex mechanism. In addition, the construction effort can be quite high. In practical applications, the stowage is furthermore elaborate because it includes multiple steps.

Consequently, there is a need in the art for enhancing loudspeaker arrangements of the initially cited type in such a way that a high-quality reproduction of music in all frequency ranges can be combined with a small space requirement.

### SUMMARY

In accordance with the present disclosure, a loudspeaker arrangement for a motor vehicle is described herein. The loudspeaker arrangement includes a housing on which a sound generator is arranged, and a mounting arrangement for fixing the loudspeaker arrangement in the motor vehicle. The mounting arrangement is configured to be fixed on an Isofix mounting of the motor vehicle.

The sound generator may be directly or indirectly mounted in the housing. For example, the sound generator may be mounted within the housing on additional mountings, which in turn are directly or indirectly connected to the housing. For example, the sound generator may consist of a loudspeaker with magnetically driven diaphragm. The sound generator may particularly be provided for generating low frequencies, i.e. it may consist of a woofer or subwoofer.

Since the mounting arrangement is configured to be fixed on an Isofix mounting of the motor vehicle, a standardized mounting of the motor vehicle can be used such that the construction of the loudspeaker arrangement is suitable for use in a large number of motor vehicles. If necessary, the loudspeaker arrangement can also be easily removed, e.g., if the Isofix mounting is required otherwise or the storage space occupied by the loudspeaker arrangement is needed. The corresponding arrangement is therefore very flexible.

According to a first enhancement, the Isofix mounting includes a Top-Tether mounting. Such a mounting is arranged on the rear side of a corresponding seat, usually in the rear row of seats or one of the rear rows of seats.

A Top-Tether mounting includes a bracket, on which elements can engage. The mounting arrangement of the loudspeaker arrangement may therefore be correspondingly configured to be mounted on the bracket of the Top-Tether mounting. Since the position and design of the Top-Tether mounting can be realized identically for multiple motor vehicles, the loudspeaker arrangement is suitable for use in a large number of different motor vehicles. In addition, the Top-Tether mounting is located on the rear side of the seat such that the loudspeaker arrangement can be fixed on the rear side of the seat, for example in the trunk of the motor vehicle.

According to another enhancement, the mounting arrangement may include a hook and/or a fastener that is designed for engaging with the Isofix mounting. In this way, the mounting arrangement can be locked or unlocked and the loudspeaker arrangement can be securely fixed in the motor vehicle. The hook or fastener may be axially adjustable and/or pivotable and/or displaceable.

According to another enhancement, a lever cooperating with the mounting arrangement may be provided on the housing in order to disengage the mounting arrangement from the Isofix mounting. In this way, the loudspeaker arrangement can be easily locked on and unlocked from the Isofix mounting.

According to an enhancement, the housing may have a rear side on which the mounting arrangement and/or the lever are arranged.

According to an enhancement, the housing may be collapsible such that it can be transferred from a collapsed state into an expanded state and vice versa. If additional space is required, for example in the trunk, the loudspeaker arrangement consequently can be collapsed in order to thereby increase the available storage space. As soon as the storage space is no longer used, the loudspeaker arrangement can be expanded again and used for generating sound.

According to an enhancement, a switch may be provided for switching the loudspeaker arrangement on or off in dependence on its state such that the loudspeaker arrangement is not operative in its collapsed state. The switch may be realized in the form of a physical switch, e.g. a momentary contact switch and/or a sensor.

According to an enhancement, the housing may have telescopic sidewalls. In this case, the telescopic sidewalls can be pushed into one another in order to transfer the housing from an expanded state into a collapsed state or vice versa.

According to an enhancement, the sidewalls may be composed of a plurality of segments. In this case, a change in the relative position between the segments can be realized.

According to another enhancement, the sidewalls may be pivotably mounted on a hinged joint. In this way, the expansion can be combined with a simultaneous pivoting motion of parts of the loudspeaker arrangement such that the orientation of the loudspeaker arrangement can be acoustically optimized. Such an axis may be provided, for example, on an upper side of the loudspeaker arrangement such that the side being collapsed is pivoted toward the rear seat, wherein an upward pivoting motion takes place during the expansion such that the emitting direction of the sound generator points upward.

According to an enhancement, the segments may include one or more damping elements and/or one or more seals. In this way, undesirable noises caused by the segments can be prevented and the housing can form a closed air volume, which is very important for the design of a loudspeaker.

According to another embodiment, the segments may form an accordion-like structure and, for example, be hinged to one another in a folding fashion or include bending points.

According to another enhancement, it is conceivable to provide at least one lock for locking the housing in the expanded state. Inadvertent collapsing of the housing can thereby be prevented.

According to another enhancement, the housing may have a front side with the sound generator arranged thereon. In this context, the front side is a side, on which no mounting arrangement is provided. In this way, the sound can be emitted into the interior rather can toward the seat.

According to an enhancement, it is conceivable to provide at least one electrical connection on the housing in order to supply the loudspeaker arrangement with energy. The electrical connection may be realized in the form of a power terminal and/or a signal terminal depending on whether the loudspeaker arrangement is designed active (with an amplifier) or passive. An additional signal terminal may be provided if the loudspeaker arrangement includes an active amplifier. This signal terminal may be a wire-bound terminal. However, a wireless transmission, e.g. via Bluetooth, may alternatively or additionally be realized.

In another aspect, the present disclosure is directed to a motor vehicle with at least one loudspeaker arrangement of the above-described type.

### BRIEF DESCRIPTION OF THE DRAWINGS

The present disclosure will hereinafter be described in conjunction with the following drawing figures, wherein like numerals denote like elements.

FIG. 1 shows a perspective view of a motor vehicle with a loudspeaker arrangement;

FIG. 2 shows a section through a motor vehicle with a loudspeaker arrangement according to the perspective view in FIG. 1;

FIG. 3 shows a rear view of the loudspeaker arrangement;

FIG. 4 shows a top view of the loudspeaker arrangement;

FIG. 5 shows a perspective view of the loudspeaker arrangement, and

FIG. 6 shows a side view of the loudspeaker arrangement.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

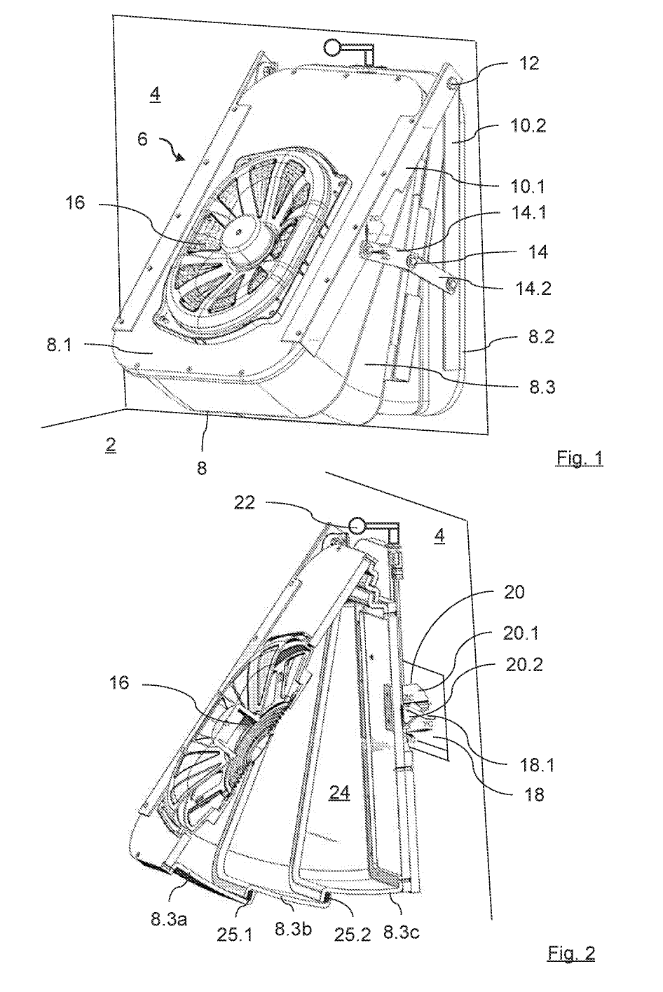

FIG. 1 shows a schematic perspective view of a motor vehicle 2. The motor vehicle 2 is equipped with a rear bench seat 4. A loudspeaker arrangement 6 is fixed on the rear bench seat 4. The loudspeaker arrangement 6 includes a housing 8. The housing 8 has a housing front side 8.1, a housing rear side 8.2 and housing sides 8.3. The housing 8 is altogether realized in a wedge-shaped fashion.

The front side 8.1 is fixed on a frame 10.1. The rear side 8.2 is fixed on a frame 10.2. The frames 10.1 and 10.2 are connected to one another by a hinged joint 12. The frames 10.1 and 10.2 can be pivoted relative to one another together with the respective front and rear sides 8.1 and 8.2 with the aid of the hinged joint 12.

The frames 10.1 and 10.2 are furthermore connected to one another with the aid of a latch 14, by which the pivoting radius of the frame 10.1 relative to the frame 10.2 can be limited. The latch consists of two rods 14.1, 14.2 that can be moved into an overextended position such that the housing 8 is locked in the expanded position.

A loudspeaker 16 is arranged on the front side 8.1. In the present example, the loudspeaker 16 is a low-range loudspeaker responsible for low frequencies. Since the human auditory system is unable to fix the position of such frequencies, the sound emission in the trunk does not create any problems.

FIG. 2 shows a cross section through the loudspeaker arrangement 6 and the rear seat 4. The rear seat 4 includes an Isofix Top-Tether mounting 18 with a mounting bracket 18.1. A mounting arrangement 20 featuring a hook 20.1 and a latch 20.2 is provided on the rear side 8.1. The hook 20.1 can be engaged with the bracket 18.1 of the Isofix Top-Tether mounting 18. The latch 20.2 encompasses the bracket 18.1 and thereby fixes the loudspeaker arrangement 6 on the Isofix Top-Tether mounting 18. A lever 22 is provided for actuating the latch 20.2, wherein said lever is more visible in FIG. 1 and makes it possible to actuate the latch 20.2.

The side 8.3 includes three segments 8.3a, 8.3b and 8.3c that can be telescopically pushed into one another. In the expanded state shown, these segments form an inner volume 24, to which the loudspeaker 16 is adapted. The segments 8.3a, 8.3b, 8.3c furthermore include seals 25.1, 25.2. In this way, undesirable noises caused by the segments 8.3a, 8.3b, 8.3c can be prevented and the housing 8 can form a closed air volume, which is very important for the design of a loudspeaker 16.

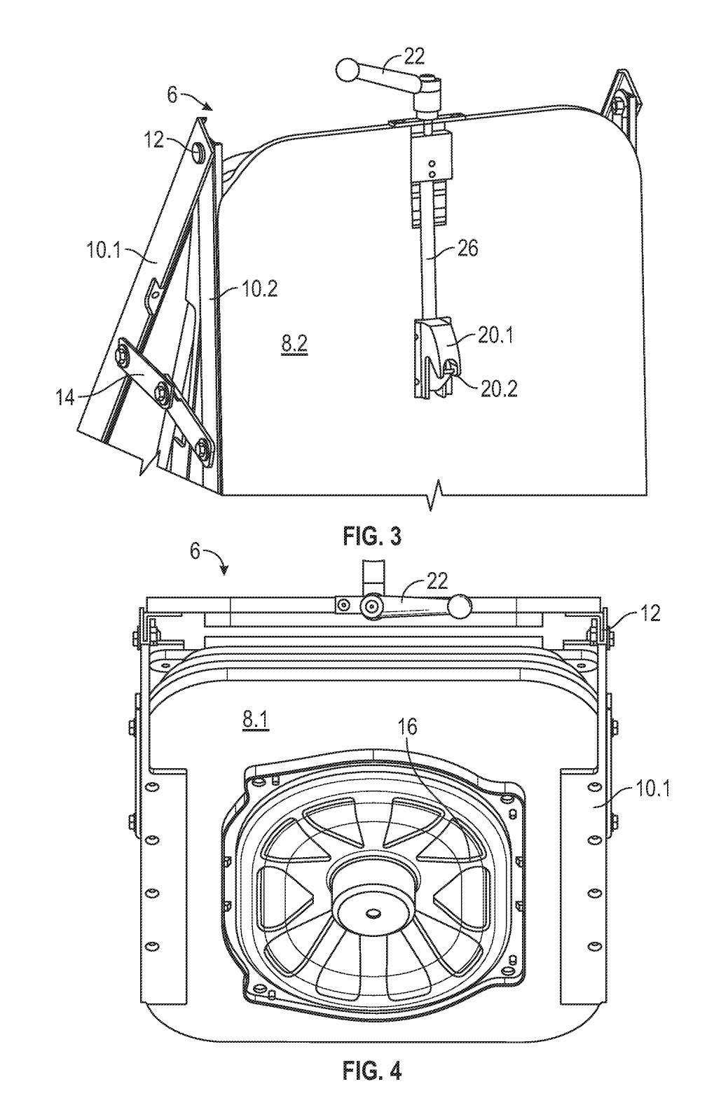

FIG. 3 shows a view of the loudspeaker arrangement 6 from its rear side 8.2. The latch 20.2 is connected to the lever 22 by a rod 26. This makes it possible to actuate the latch 20.2. The height of the latch 20.1 can be adjusted by the lever 22 in such a way that the loudspeaker arrangement is clamped on the Isofix Top-Tether mounting 18 (not illustrated in FIG. 3) free of play. The rear side 8.2 is designed for resting against the rear seat 4. The rear side 8.2 is realized in such a way that no booms are created. This can be achieved, among other things, with a suitable material selection, damping elements, cover fabrics or the design of the mounting.

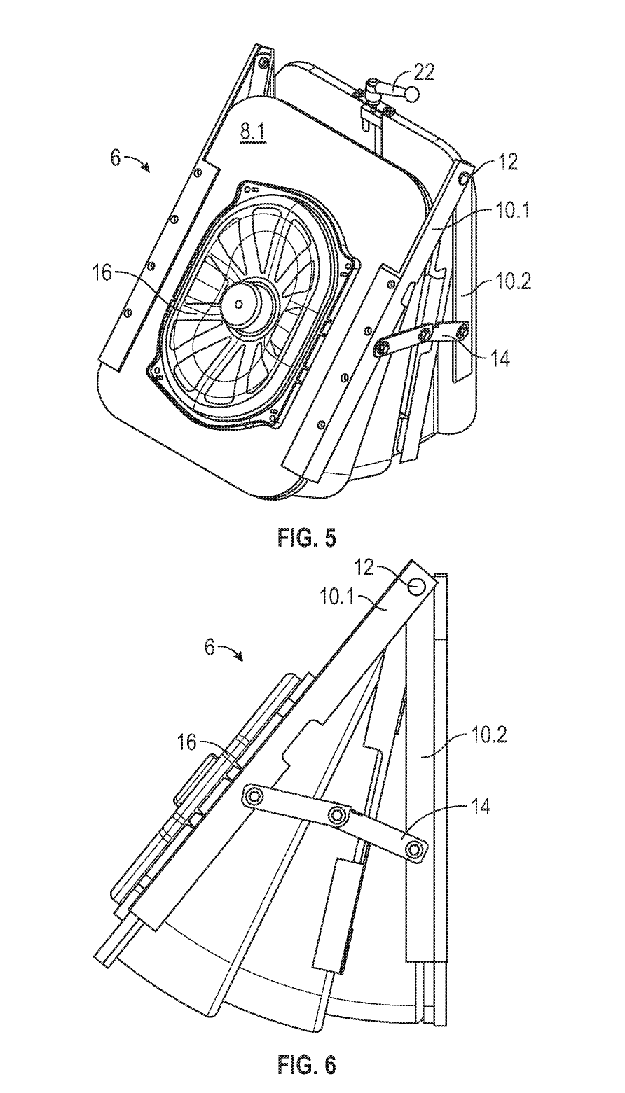

FIG. 4 shows a top view of the loudspeaker arrangement 6 in the expanded state. FIG. 5 shows a perspective view of the loudspeaker arrangement 6. FIG. 6 shows a side view of the loudspeaker arrangement 6.

A shoulder 28 is arranged on the segment 8.3c. The latch 14 is guided on said shoulder. A recess 30 is provided on the frame 10.1 and serves for accommodating parts of the latch 14.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-14. (canceled)

15. A loudspeaker arrangement for a motor vehicle comprising:
a housing;
at least one sound generator arranged on the housing; and
at least one mounting arrangement configured to fix the loudspeaker arrangement on an IsoFix mounting in the motor vehicle.

16. The loudspeaker arrangement according to claim 15, wherein the IsoFix mounting comprises a top-tether mounting.

17. The loudspeaker arrangement according to claim 15, wherein the mounting arrangement comprises at least one of a hook and a fastener configured to engage the IsoFix mounting.

18. The loudspeaker arrangement according to claim 15, further comprising a lever provided on the housing and cooperating with the mounting arrangement to disengage the mounting arrangement from the IsoFix mounting.

19. The loudspeaker arrangement according to claim 15, wherein the housing further comprises a rear side, wherein at least one of the mounting arrangement and the lever are arranged on the rear side.

20. The loudspeaker arrangement according to claim 15, further comprising a collapsible housing such that the housing is transferrable between a collapsed state and an expanded state.

21. The loudspeaker arrangement according to claim 20, wherein the housing comprises telescopic sidewalls.

22. The loudspeaker arrangement according to claim 21, wherein each telescopic sidewall comprises a plurality of segments.

23. The loudspeaker arrangement according to claim 22, wherein at least one segment comprises a damping element.

24. The loudspeaker arrangement according to claim 22, wherein at least one segment comprises a seal.

25. The loudspeaker arrangement according to claim 21, wherein the housing further comprises a hinged joint pivotably mounting the telescopic sidewalls.

26. The loudspeaker arrangement according to claim 20, wherein the housing further comprises a lock configured to lock the housing in the expanded state.

27. The loudspeaker arrangement according to claim 15, wherein the housing comprises a front side, wherein the sound generator is arranged on the front side.

28. The loudspeaker arrangement according to claim 15, further comprising an electrical connection provided on the housing and configured to supply the sound generator with energy.

29. A motor vehicle with a loudspeaker arrangement according to claim 15.

30. A loudspeaker arrangement for a motor vehicle comprising:
a collapsible housing having a front side, a rear side and a telescopic sidewall configured to transfer the housing a collapsed state and an expanded state;
at least one sound generator arranged on the front side of the housing; and
at least one mounting arrangement arranged on the rear side of the housing and configured to fix the loudspeaker arrangement on a top tether mounting in the motor vehicle
a lever provided on the housing and cooperating with the mounting arrangement to disengage the mounting arrangement from the top tether mounting;
a lock configured to lock the housing in the expanded state; and
an electrical connection provided on the housing and configured to supply the sound generator with energy.
